(19) United States
(12) Patent Application Publication
(10) Pub. No.: US 2004/0083871 A1
(43) Pub. Date: May 6, 2004

(54) Twist-tie dispenser

(76) Inventor: Paul S. Mosher, Strathmore (CA)

Correspondence Address: MARIO D. THERIAULT, 812 HWY. 101 NASONWORTH, FREDERICTON, NB, E3C 2B5, CA

(21) Appl. No.: 10/617,088

(22) Filed: Jul. 11, 2003

(30) Foreign Application Priority Data
Jul. 12, 2002 (CA) 2,393,335

(51) Int. Cl. B26D 1/12

(52) U.S. Cl. 83/663

(57) ABSTRACT

The twist-tie dispenser has a pair of pinch wheels on its infeed side, and a cutter wheel rolling against an anvil wheel near its outlet side. A crank and a spring are used to forcefully advance the cutter wheel over about half a turn per full rotation. The cutter wheel has a cutter blade mounted therein which rolls against the anvil wheel. A continuous twist-tie stock is fed between the pinch wheels and between the cutter wheel and the anvil wheel and extends to protrude through the outlet side of the dispenser. A pulling of the twist tie material on the outlet side causes the cutter wheel to rotate and to extend the spring. As the spring pass the over-centre position, it swiftly urges the cutter wheel to severe a twist tie and to advance the end of the tie stock outside the dispenser for a subsequent cycle.

### FIELD OF THE INVENTION

This invention pertains to apparatus for paying out single twist ties from a spool of twist-tie stock material.

### BACKGROUND OF THE INVENTION

It is believed that there is no prior art related to twist-tie dispenser for paying out twist ties from a continuous strip of twist-tie stock material.

### SUMMARY OF THE INVENTION

The twist-tie dispenser according to the present invention has a pair of pinch wheels on its infeed side. A pawl acts against one of the pinch wheels to prevent a back rotation of that pinch wheel. The dispenser also has a cutter wheel rolling against an anvil wheel near the outlet side thereof. A crank and a spring are used to forcefully advance the cutter wheel over about half a turn per full rotation of the cutter wheel.

The cutter wheel has a cutter blade therein. The cutter blade rolls against the anvil wheel during the impelled half turn. A strip of twist tie material is fed between the pinch wheels and between the cutter wheel and the anvil wheel and extends to protrude through the outlet side. A pulling of the twist tie material on the outlet side causes the cutter wheel to rotate and to extend the spring over about half a turn of the cutter wheel.

The spring and lever impart momentum into the cutter wheel over the other half a turn, thereby cutting the twist tie with energy. The cutter blade rolls against the anvil wheel at about half way through, or slightly before the impelled half turn such that after severing a twist tie, the cutting wheel advances the end of the twist tie material outside the dispenser for a subsequent cycle.

Other advantages and novel features of the present invention will become apparent from the following detailed description of the preferred embodiment.

### BRIEF DESCRIPTION OF THE DRAWINGS

One embodiment of the present invention is illustrated in the accompanying drawings, in which like numerals denote like parts throughout the several views, and in which:

FIG. 1 is a top view of the twist-tie dispenser;

FIG. 2 is cross-section view of a first side of the twist-tie dispenser as seen along line-2-2 in FIG. 1;

FIG. 3 is a second side view of the twist-tie dispenser, opposite the first side;

FIG. 4 is a first schematic illustration of the operation of the twist-tie dispenser, with the cutter wheel in a pre-cutting position, the spring fully extended and the crank in an over-centre angle; and

FIG. 5 is a second schematic illustration of the operation of the twist-tie dispenser with the cutter wheel in a rest position.

### DESCRIPTION OF THE PREFERRED EMBODIMENT

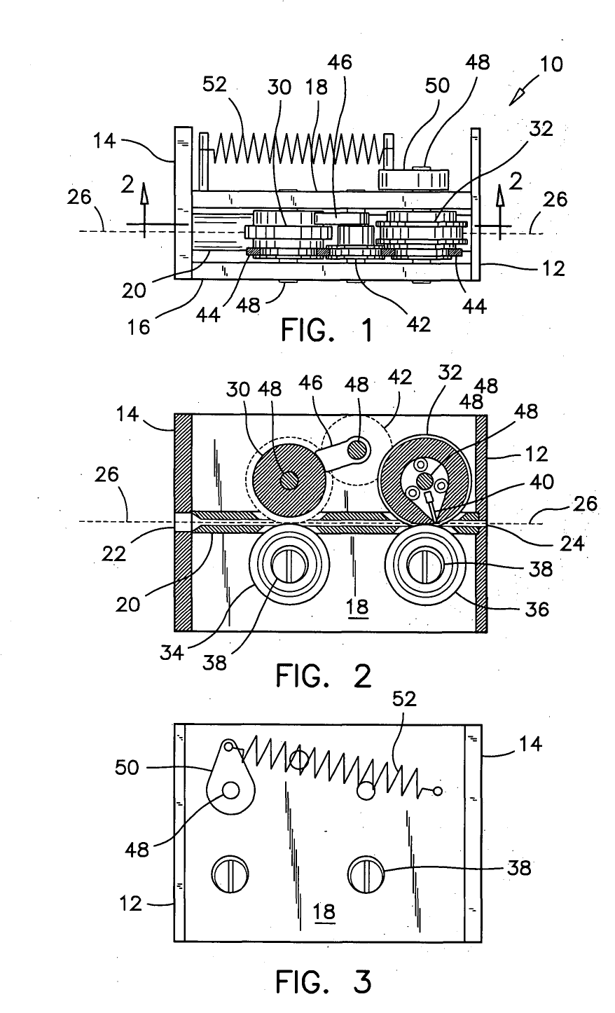

Referring to the illustrations in FIGS. 1-3, the twist-tie dispenser 10 according to the preferred embodiment of the present invention comprises a frame made of a front plate 12, a back plate 14, a side plate 16 and a middle plate 18. A feed tube 20 extends from a first opening 22 in the back plate 14 to a second opening 24 in the front plate 12. The feed tube 20 defines a feed axis 26 through the twist-tie dispenser 10.

A pair of upper slots (not shown) in the feed tube 20 accommodate a tie-feed wheel 30 and a tie-cutter wheel 32 next to each other and tangent to the feed axis 26. Similarly, the feed tube 20 has a pair of lower slots (not shown) to accommodate a first pinch wheel 34 under the tie-feed wheel 30 and a second pinch wheel 36 under the tie-cutter wheel 32. The second pinch wheel 36 acts as an anvil for the cutter blade and is also referred to herein as the anvil wheel.

The first and second pinch wheels 34, 36 are mounted on cam-screw axles 38 such that these pinch wheels are movable up and down upon a working of the cam-screw axles 38 with a screw driver for example. The first and second pinch wheels 34, 36 preferably consist of ball or roller bearings.

The tie-cutter wheel 32 has a sharp blade 40 mounted radially therein. The clearance between the tip of the blade 40 and the surface of the second pinch wheel 36 is less than one thousandth of an inch, such that a twist-tie stock passing along the feed axis 24 is severed at each rotation of the cutter wheel 32.

An idler wheel 42 is mounted between the tie-feed wheel 30 and the tie-cutter wheel 32. The idler wheel 42 is engaged with both the tie-feed wheel 30 and the tie-cutter wheel 32, by means of intermeshed gear teeth, or by means of plastic or rubber tires 44 mounted around the tie-feed wheel 30 and the tie-cutter wheel 32, or around the idler wheel 42 itself.

The tie-feed wheel 30 and the tie-cutter wheel 32 have a same rolling diameter and the idler wheel 42 ensures that these two wheels rotate together a same angle at each cycle.

A pawl 46 is preferably provided to prevent a back rotation of the tie-feed wheel 30 and the tie-cutter wheel 32. The pawl 46 is mounted on the same axis as the idler wheel 42 and extends to touch the rim of the tie-feed wheel 30. It will be appreciated that the length of the pawl 46 is selected to pry against and grip the rim surface of the tie-feed wheel 30, when this wheel is rotated backward.

The tie-feed wheel 30, the tie-cutter wheel 32 and the idler wheel 42 are mounted on respective axles 48 extending between the side plate 16 and the middle plate 18. Both cam-screw axles 38 also extend between the side plate 16 and the middle plate 18.

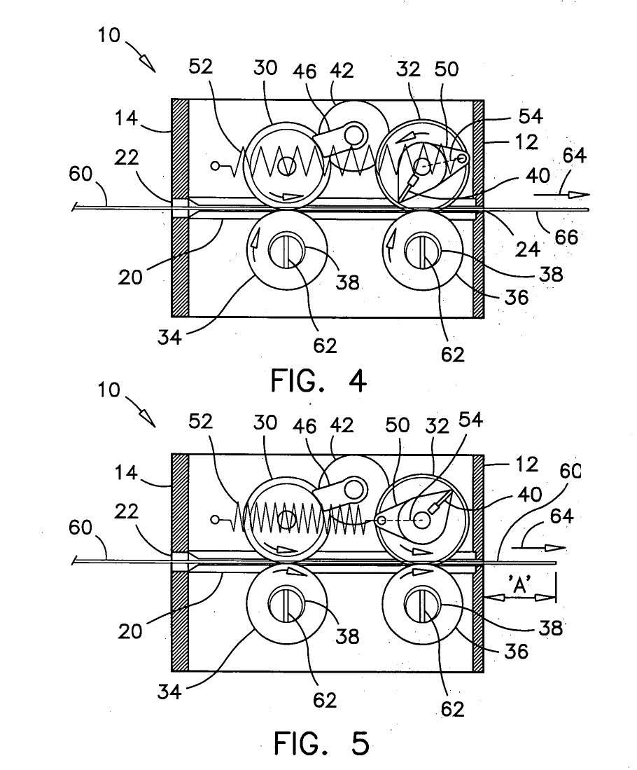

Behind the middle plate 18, relative to the tie-cutter wheel 32, there is provided a crank 50 keyed to the tie-cutter wheel axle 48. An extension spring 52 extends between a first pin on the tip of the crank 50 and a second pin at the back end of the middle plate 18. The lever line 54 of the crank 50 makes an angle of over 90° and preferably closer to 135°-145° with the cutter blade 40 as illustrated in FIG. 4.

In use, the tie stock 60 is preferably fed from a spool (not shown) of continuous tie stock. The loading of the tie stock 60 into the dispenser 10 is effected by firstly turning the cam screws 62 to increase the clearance between the pinch wheels 34, 36 and the tie-feed wheel 30 and the tie-cutter wheel 32. The tie stock 60 is then inserted through the first opening 22, into the feed tube 20 and through the second opening 24. The cam screws 62 are then readjusted to pinch the tie stock 60 against the tie-feed wheel 30 and the tie-cutter wheel 32.

In use, the tie stock 60 projecting outside the front plate 12 is simply pulled away as shown by arrow 64 in FIGS. 4 and 5. As the tie stock 60 is being pulled, the pressure between the pinch bearings 34, 36 and the tie-feed wheel 30 and the tie-cutter wheel 32, and the engagement of the idler wheel 42 cause all the wheels to rotate together. A pulling on the tie stock 60 also causes the spring 52 to extend until the lever line 54 is pointing forward parallel to the feed axis 26.

Upon continued rotation, the crank 50 reaches an over-centre position as illustrated in FIG. 4, before the cutter blade 40 rotates against the surface of the second pinch wheel 36. The force of the spring 52 causes the tie-cutter wheel to rotate swiftly and to severe a twist tie 66 from the tie stock 60. The force of the spring 52 and the momentum of the tie-cutter wheel 32 causes the tie-cutter wheel 32 to rotate forcefully pass the cutting point and to continue to an angle where the spring 52 has reached its shortest length, as illustrated in FIG. 5.

The spring-induced rotation of the tie-cutter wheel 32 has the effect of easily severing a twist tie 66 and advancing the tie stock 60 a substantial distance ‘A’ outside the front plate 12 such that it is easy to grab and pull another twist tie from the dispenser.

It will be appreciated that the mechanism disclosed herein above and illustrated in the drawings is mounted inside a protective and visually-pleasing housing, which may also include a reel to support a spool of twist-tie stock material. However, such housing and reel are not the focus of the present invention, and therefore have not been illustrated and described.

While one embodiment of this invention has been illustrated in the accompanying drawings and described herein above, it will be evident to those skilled in the art that changes can be made therein without departing from the essence of this invention. Therefore the above description and the illustrations should not be construed as limiting the scope of the invention which is defined by the following claims.

I claim:

1. A dispenser for paying out individual twist ties from a strip of continuous twist tie material, comprising:
a frame having an infeed side, an outlet side and a feed axis extending between said infeed side and said outlet side;
a pinch wheel pair mounted in said frame near said infeed side, astride said feed axis;
a cutter wheel and anvil wheel pair mounted near said outlet side astride said feed axis;
said cutter wheel having a cutter blade mounted radially therein;
means for feeding a strip of twist tie material along said feed axis between said cutter wheel and said anvil wheel;
means for rotating said cutter wheel against said anvil wheel for severing a twist tie from said strip of twist tie material, and
means for advancing said strip of twist tie material along said feed axis after a twist tie has been severed from said strip of twist tie material.

2. The dispenser as claims in claim 1, wherein said means for advancing said strip of tie material comprises a crank on said cutter wheel and a spring attached to said crank and said frame.

3. The dispenser as claimed in claim 2, wherein said crank has a lever line making an angle greater than 90° with said cutter blade.

4. The dispenser as claimed in claim 1, wherein said means for rotating also comprises means for increasing a momentum of said cutter wheel.

5. The dispenser as claimed in claim 4, wherein said means for rotating further comprises means for swiftly urging said cutter blade against said anvil wheel.

6. The dispenser as claimed in claim 1, further comprising means for turning said pinch wheel pair and said cutter wheel and anvil wheel pair in unison.

7. The dispenser as claimed in claim 6, wherein said means for turning comprises means for preventing a back rotation of said pinch wheel pair.

8. The dispenser as claimed in claim 7, wherein said means for preventing a back rotation comprises a pawl in contact with a rim surface on said pinch wheel pair.

9. The dispenser as claimed in claim 6, wherein said means for turning comprises an idler wheel engaged with said pinch wheel pair and said cutter wheel.

10. The dispenser as claimed in claim 1, wherein said pinch wheel pair comprises an axle and a cam screw on said axle for adjusting a gap thereof.
